(19) United States
(12) Patent Application Publication
(10) Pub. No.: US 2009/0142576 A1
(43) Pub. Date: Jun. 4, 2009

(54) Filter and method for making the same

(75) Inventors: Chang-Hong Liu, Beijing (CN); Ding Wang, Beijing (CN); Shou-Shan Fan, Beijing (CN)

Correspondence Address: PCE INDUSTRY, INC.;ATT. Steven Reiss, 458 E. LAMBERT ROAD, FULLERTON, CA, 92835, US

(73) Assignees: Tsinghua University, Beijing City (CN); HON HAI Precision Industry CO., LTD., Tu-Cheng City (TW)

(21) Appl. No.: 12/218,898

(22) Filed: Jul. 17, 2008

(30) Foreign Application Priority Data
Nov. 30, 2007 (CN) 200710077455.3

(51) Int. Cl. B32B 3/26; B29C 67/20

(52) U.S. Cl. 428/315.5; 264/117; 977/742

(57) ABSTRACT

A filter includes a carbon nanotube film. The carbon nanotube film includes a plurality of linear carbon nanotubes, the linear carbon nanotubes being entangled with each other to form a number of micropores, wherein the diameters of the micropores are less than 10 nanometers. The method for making the filter includes the following steps: (a) providing a carbon nanotube array formed on a substrate; (b) removing the carbon nanotube array from the substrate to obtain a raw material of carbon nanotubes; (c) adding the raw material of carbon nanotubes into a solvent to obtain a flocculent structure; and (d) separating the flocculent structure from the solvent and shaping the flocculent structure to obtain a filter.

### BACKGROUND

1. Field of the Invention

The present invention relates to filters and methods for making the same.

2. Discussion of Related Art

Carbon nanotubes (CNTs) produced by means of arc discharge between graphite rods were first discovered and reported by Sumio Iijima in 1991. CNTs are electrically conductive along their length, chemically stable, and each can have a very small diameter (much less than 100 nanometers) and large aspect ratios (length/diameter). Due to these and other properties, it has been suggested that CNTs can play an important role in manufacturing filters.

A conventional filter incorporating CNTs includes a filtration substrate and a carbon nanotube filtration membrane located thereon. Referring to FIG. 6, the carbon nanotube filtration membrane includes a plurality of branch-like carbon nanotubes. The branch-like carbon nanotubes are selected from the group consisting of T-type carbon nanotubes, Y-type carbon nanotubes, and H-type carbon nanotubes. Each branch-like carbon nanotube includes at least one junction.

One conventional method for making the filter includes the following steps: providing a plurality of carbon nanotube saw material, the carbon nanotube saw material includes a plurality of branch-like carbon nanotubes; oxidizing the branch-like carbon nanotubes; dispersing the branch-like carbon nanotubes into a solvent to form a suspension; filtering the suspension via a filtration film to form a preform of carbon nanotube film; firing the preform of the carbon nanotube film in a vacuum to form a carbon nanotube film; and removing the carbon nanotube film from the filtration film and attaching the carbon nanotube film onto a filtration substrate to obtain the filter.

However, in the filter, the carbon nanotube film has to be attached onto a filtration substrate because of the poor flexility and free-standing property of the carbon nanotube film. Due to the diameters of the carbon nanotubes in the filter being bigger than 15 nanometers, the pores in the filter are too big to obtain better filtration results. Additionally, the method for making the above-described filter has problems such as difficulty in dispersing the branch-like carbon nanotubes into solvent. Furthermore, the step of firing to form the carbon nanotube film has complicated the fabrication procedure, thereby increasing the overall cost.

What is needed, therefore, is to provide a filter and method for making the same in which the carbon nanotube film has excellent flexibility, free-standing property, better filtration result, and can easily be made.

### BRIEF DESCRIPTION OF THE DRAWINGS

Many aspects of the present invention of the filter and method for making the same can be better understood with references to the following drawings.

FIG. 1 shows a schematic view of a filter in accordance with a present embodiment;

FIG. 2 shows a Scanning Electron Microscope (SEM) image of the filter shown in FIG. 1;

FIG. 3 is a flow chart of a method for making the filter shown in FIG. 1;

FIG. 4 shows a photo of a carbon nanotube flocculent structure formed by the method of FIG. 3;

FIG. 5 shows a photo of a carbon nanotube film formed by the method of FIG. 3; and

FIG. 6 shows a schematic view of the carbon nanotubes in a conventional filter according to the prior art.

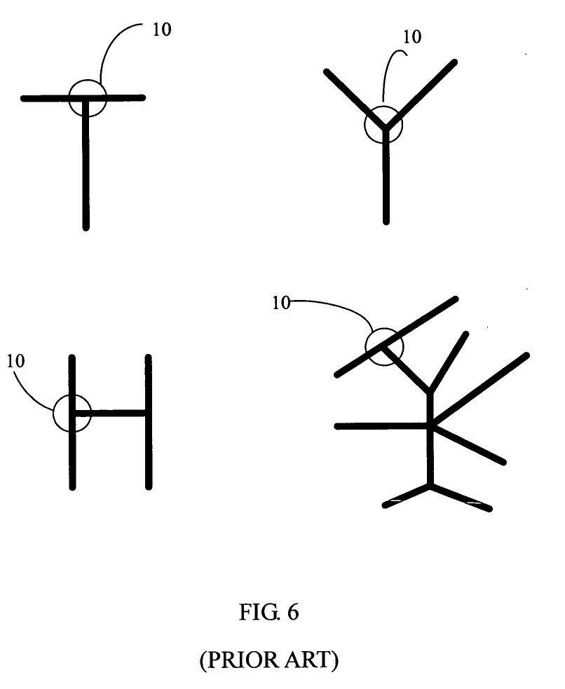

Corresponding reference characters indicate corresponding parts throughout the several views. The exemplifications set out herein illustrate at least one preferred embodiment of the present invention of the filter and method for making the same, in at least one form, and such exemplifications are not to be construed as limiting the scope of the invention in any manner.

### DETAILED DESCRIPTION OF PREFERRED EMBODIMENTS

References will now be made to the drawings to describe embodiments of the present filter and method for making the same, in detail.

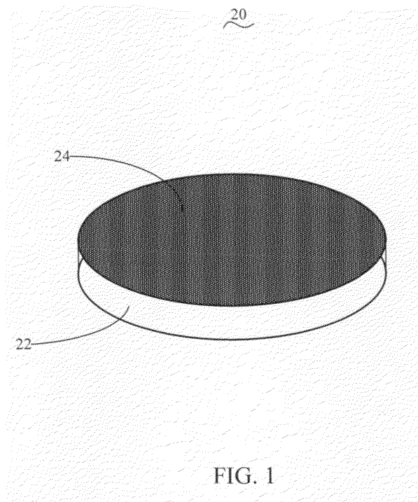

Referring to FIG. 1, the present invention provides a filter 20. The filter 20 includes a filtration substrate 22 and carbon nanotube film 24.

The filtration substrate 22 is a porous supporting component. such as porous ceramic sheets or porous fiber polymer boards. The filtration substrate 22 has a porous structure and contains a plurality of micropores. Diameters of the micropores in the filtration substrate 22 are less than or equal to 4 micrometers. In the present embodiment, the filtration substrate 22 is a porous ceramic sheet. The filtration substrate 22 is used to support the carbon nanotube film 24 and alleviate the stretching force of the carbon nanotube film 24, thereby prolonging the life of the filter 20.

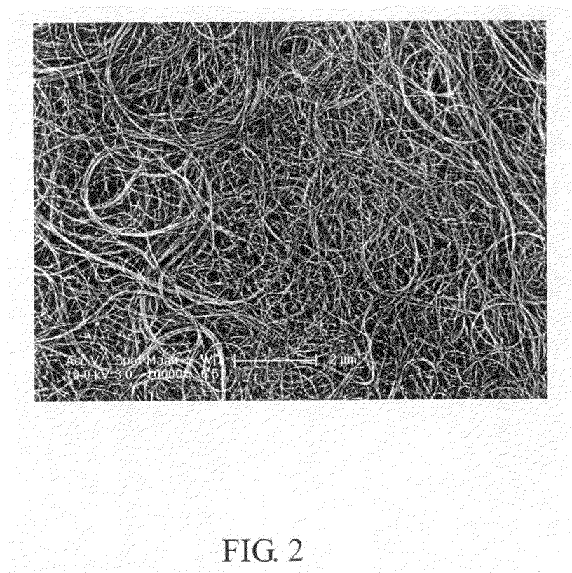

The carbon nanotube film 24 can be placed on an upper surface, a lower surface, or both the upper surface and the lower surface of the filtration substrate 22. The carbon nanotube film 24 can be attached or formed on the surface of the filtration substrate 22 by means of directly pressing, directly forming, or binding. A thickness of the carbon nanotube is more than 10 micrometers. Referring to FIG. 2, the carbon nanotube film 24 includes a plurality of linear carbon nanotubes entangled with each other. The linear carbon nanotubes in the carbon nanotube film 24 are isotropic and uniformly distributed, and disorderly arranged to form a micropore structure. The micropore structure has a number of micropores. Diameters of the micropores are less than 100 nanometers and, preferably, less than 10 nanometers. The linear carbon nanotubes are bundled together by van der Walls attractive force therebetween to form a network structure. Thus, the carbon nanotube film 24 is so flexible that it can be used to make different shapes of the filter 20. The linear carbon nanotube is a single carbon nanotube. A length of the single carbon nanotube is more than 100 micrometers and the diameters of the single carbon nanotube are less than 15 nanometers. The single carbon nanotube is selected from the group consisting of single-walled carbon nanotubes, double-walled carbon nanotubes, and multi-walled carbon nanotubes.

Different areas of the carbon nanotube film 24 can be obtained according to the method for making the carbon nanotube film 24. The carbon nanotube film 24 can be cut into various shapes according to practical needs. In the present embodiment, a width of the carbon nanotube film 24 approximately ranges from 1 to 10 centimeters. A thickness of the carbon nanotube film 24 approximately ranges from 10 micrometers to 1 millimeter. The size of the carbon nanotube film 24 may be arbitrarily set.

The filtration substrate 22 in the nanotube filter 20 in the present embodiment is optional. Specifically, the nanotube filter 20 may only include the carbon nanotube film 24. Due to the linear carbon nanotubes in the carbon nanotube film 24 being bundled together by van der Walls attractive force to form a network structure, the carbon nanotube film 24 has good free-standing and tensile properties. Therefore, in practical use, the carbon nanotube film 24 can be used as the filter 20 without the filtration substrate 22.

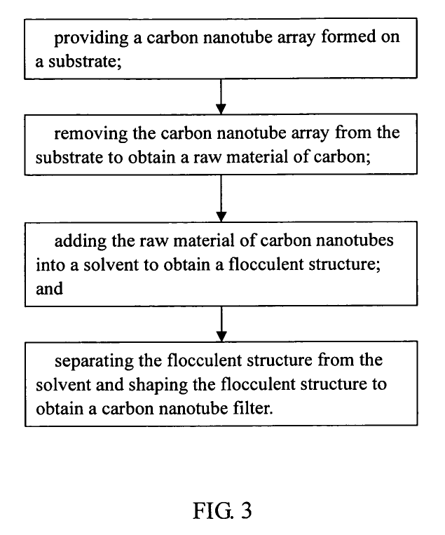

Referring to FIG. 3, a method for making the filter 20 includes the following steps: (a) providing a carbon nanotube array formed on a substrate; (b) removing the carbon nanotube array from the substrate to obtain a raw material of carbon nanotubes; (c) adding the raw material of carbon nanotubes into a solvent to obtain a flocculent structure; and (d) separating the flocculent structure from the solvent and shaping the flocculent structure to obtain a filter.

In step (a), the super-aligned array of carbon nanotubes can be formed by the following substeps: (a1) providing a substantially flat and smooth substrate; (a2) forming a catalyst layer on the substrate; (a3) annealing the substrate with the catalyst at 700 to 900° C. in an atmosphere such as air for 30 to 90 minutes; (a4) heating the substrate with the catalyst up to the rang of 500 to 740° C. in a furnace in protective gas; (a5) supplying a carbon source gas into the furnace for 5 to 30 minutes and growing the super-aligned array of the carbon nanotubes from the substrate.

In step (a1) the substrate can be a P-type silicon wafer, an N-type silicon wafer, or a silicon wafer with a film of silicon oxide thereon. In the present embodiment, a 4-inch P-type silicon wafer is used as the substrate.

In step (a2) the catalyst can be made of iron (Fe), cobalt (Co), nickel (Ni), or any combination alloy thereof.

In step (a4) the protective gas can be nitrogen (N₂) gas, ammonia (NH₃) gas or noble gas. In step (a5) the carbon source gas can be a hydrocarbon gas such as ethylene (C₂H₄), methane (CH₄), acetylene (C₂H₂), ethane (C₂H₆) or any combination thereof.

The super-aligned array of carbon nanotubes can be approximately 200 to 400 micrometers in height and includes a plurality of linear carbon nanotubes parallel to each other and nearly perpendicular to the substrate. The super-aligned array of carbon formed under the above conditions is essentially free of impurities such as carbonaceous or residual catalyst particles. The linear carbon nanotubes in the super-aligned array are packed together closely by van der Waals attractive force.

In step (b), the array of carbon nanotubes is scraped off the substrate by a blade or other similar devices to obtain the raw material of carbon nanotubes. The raw material includes a plurality of linear carbon nanotubes entangled with one another. Each linear carbon nanotube is a single carbon nanotube. A length of the single carbon nanotube is more than 100 micrometers and the diameters of the single carbon nanotubes are less than 15 nanometers.

In step (c), the solvent is selected from a group consisting of water and volatile organic solvent. After adding the plurality of carbon nanotubes to the solvent, a process of flocculating the carbon nanotubes is executed to create the carbon nanotube flocculent structure. The process of flocculating the carbon nanotubes is selected from the group consisting of ultrasonic dispersion of the carbon nanotubes and agitating the carbon nanotubes. In present embodiment, ultrasonic dispersion is used to flocculate the solvent containing the carbon nanotubes for about 10˜30 minutes. Due to the carbon nanotubes in the solvent having a large specific surface area and the tangled carbon nanotubes utilizing van der Waals attractive force, the flocculated and tangled carbon nanotubes form a network structure (i.e., flocculent structure).

In step (d), the process of separating the flocculent structure from the solvent includes the following substeps: (d1) filtering out the solvent to obtain the carbon nanotube flocculent structure; and (d2) drying the carbon nanotube flocculent structure to obtain the separated carbon nanotube flocculent structure.

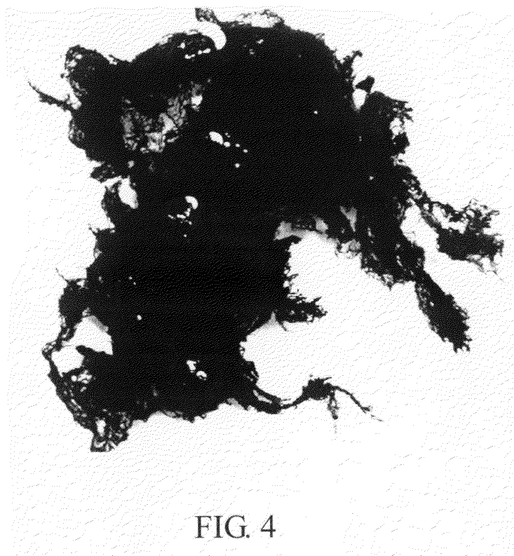

In step (d2), the carbon nanotube flocculent structure can be stored at room temperature for a period of time to dry the organic solvent therein. The time of drying can be selected according to practical needs. Referring to FIG. 4, on the filter, the carbon nanotubes in the carbon nanotube flocculent structure are tangled together.

In step (d), the process of shaping includes the following substeps: (d3) spreading the carbon nanotube flocculent structure to form a predetermined structure; (d4) pressing the spread carbon nanotube flocculent structure with a certain pressure to yield a desirable shape; and (d5) removing the residual solvent contained in the spread flocculent structure to form the carbon nanotube film 24.

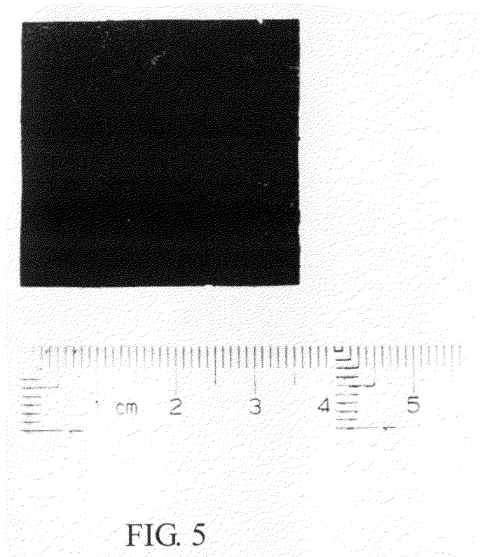

The size of the spread flocculent structure will determine a thickness and a surface density of the carbon nanotube film 24. As such, the larger the area of the flocculent structure, the less the thickness and density of the carbon nanotube film 24. A thickness of the carbon nanotube film 24 approximately ranges from 10 micrometers to 1 millimeter, while a width of the carbon nanotube film 24 approximately ranges from 1 to 10 centimeters. Referring to FIG. 5, in the embodiment, a thickness of the carbon nanotube film 24 approximately 0.5 millimeter, while a width of the carbon nanotube film 24 approximately 3.5 centimeters.

It will be apparent to those having ordinary skill in the field of the present invention that the size of the carbon nanotube film 24 can be arbitrarily set and depends on the actual needs of utilization. The carbon nanotube film 24 can be cut into smaller sizes and different shapes in open air.

Furthermore, a filtration substrate 22 is provided and the carbon nanotube film 24 is attached onto at least one surface of the filtration substrate 22. The carbon nanotube film 24 can be attached on the surface of the filtration substrate 22 by means of directly pressing or sticking with a binder.

The carbon nanotube film 24 can also be formed on the surface of the filtration substrate 22 directly via the process of filtration pumping. The process of filtration pumping includes the following substeps: (d1′) providing a filtration substrate 22 and an air-pumping funnel; (d2′) adding the carbon nanotube flocculent structure onto the filtration substrate 22 and putting the filtration substrate 22 into the air-pumping funnel; (d3′) filtering out the solvent from the carbon nanotube flocculent structures via the filtration substrate 22 using the air-pumping funnel; and (d4′) drying the carbon nanotube flocculent structures attached on the filtration substrate 22.

In step (d1′) of the present embodiment, the filtration substrate 22 is a porous ceramic sheet having a smooth surface. Diameters of the micropores in the filtration substrate 22 are approximately 4 micrometers. The filtration pumping process can exert air pressure on the flocculent structure, thereby forming the uniform carbon nanotube film 24. Moreover, due to the filtration substrate 22 having a smooth surface, the carbon nanotube film 24 can easily be separated. The carbon nanotube film 24 can be separated from the filtration substrate 22 to be used as a filter 20 or can be used as a filter 20 with the filtration substrate 22 together.

The carbon nanotube film 24 includes a plurality of linear carbon nanotubes. The linear carbon nanotubes in the carbon nanotube film 24 are isotropic and uniformly distributed, disorderly arranged, and entangled to one another to form a number of micropores. The diameters of the micropores are less than 100 nanometers and, preferably, less than 10 nanometers by controlling the density of the carbon nanotube film 24. If the carbon nanotube film 24 is made of single-walled carbon nanotubes, the diameters of the micropores are about 1 nanometer. Therefore, the filter 20 is suitable to filtrate impurity grains having diameters greater than 2 nanometers. The linear carbon nanotubes are bundled together by van der Walls attractive force to form a network structure. Thus, the carbon nanotube film 24 has a better flexibility.

Furthermore, the property of the filter 20 is tested. In the present experiment, the thickness of the carbon nanotube film 24 is 10 micrometers and used as the filter 20. The testing solution is selected from the group consisting of a blue-black solution of ink for pen, a red solution of ink for a printer and a light blue solution of saturated copper sulfate. After filtering, the three solutions become transparent. Diameters of the solutes in the solution are less than 10 nanometers. From the test results, the filter 20 is useful in fields such as material purification, environment protection, sanitation and scientific research et al.

The present filter includes a carbon nanotube film and has the following advantages. Firstly, the carbon nanotube film has a number of micropores with diameters being less than or equal to 10 nanometers, thus making the filter have a better filtration result. Secondly, the carbon nanotube film has excellent flexility and free-standing property, thus making the filter could be used as a filter without any filtration substrate and have a long lifetime. The way in which the instant filter is created also decreasing the complexity in which conventional nanotube filters are fabricated.

Finally, it is to be understood that the above-described embodiments are intended to illustrate rather than limit the invention. Variations may be made to the embodiments without departing from the spirit of the invention as claimed. The above-described embodiments illustrate the scope of the invention but do not restrict the scope of the invention.

What is claimed is:

1. A filter, comprising:
a carbon nanotube film comprising a plurality of linear carbon nanotubes, the linear carbon nanotubes being entangled with each other and bundled together only by van der Walls attractive force therebetween and form a number of micropores, the relative diameters of the micropores are less than 10 nanometers.

2. The filter as claimed in claim 1, wherein the linear carbon nanotubes in the carbon nanotube film are isotropic, uniformly distributed, and disorderly arranged.

3. The filter as claimed in claim 1, wherein a thickness of the carbon nanotube film approximately ranges from 10 micrometers to 1 millimeter.

4. The filter as claimed in claim 1, wherein each linear carbon nanotube is a single carbon nanotube.

5. The filter as claimed in claim 4, wherein the length of the linear carbon nanotubes is more than 100 micrometers, and diameters of the linear carbon nanotubes are less than 10 nanometers.

6. The filter as claimed in claim 4, wherein the carbon nanotubes are selected from the group consisting of single-walled carbon nanotubes, double-walled carbon nanotubes, and multi-walled carbon nanotubes.

7. The filter as claimed in claim 1, further comprising a filtration substrate, and the carbon nanotube film is located on a surface of the filtration substrate.

8. The filter as claimed in claim 7, wherein the filtration substrate is selected from the group consisting of porous ceramic sheets and porous fiber polymer boards.

9. The filter as claimed in claim 7, wherein the filtration substrate includes a plurality of micropores, and diameters of the micropores are less than or equal to 4 micrometers.

10. A method for making a filter, the method comprises of:
(a) providing carbon nanotubes;
(b) adding the carbon nanotubes into a solvent;
(c) flocculenting the carbon nanotubes to obtain a flocculent structure; and
(d) separating the flocculent structure from the solvent and shaping the flocculent structure to obtain a filter.

11. The method as claimed in claim 10, wherein the providing carbon nanotubes comprises the substeps of: providing a carbon nanotube array formed on a substrate; and removing the carbon nanotube array from the substrate to obtain the carbon nanotubes.

12. The method as claimed in claim 11, wherein the carbon nanotube array is scraped off the substrate.

13. The method as claimed in claim 11, wherein the carbon nanotube array comprises two or more linear carbon nanotubes that are entangled with each other.

14. The method as claimed in claim 10, wherein the solvent is selected from a group consisting of water and volatile organic solvent.

15. The method as claimed in claim 10, wherein the flocculating the carbon nanotubes is selected from the group consisting of ultrasonic dispersion of the carbon nanotubes and agitating the carbon nanotubes.

16. The method as claimed in claim 10, wherein the separating the flocculent structure from the solvent comprises the substeps of:
(d1) filtering out the solvent to obtain the carbon nanotube flocculent structure; and
(d2) drying the carbon nanotube flocculent structure to obtain the separated carbon nanotube flocculent structure.

17. The method as claimed in claim 10, wherein the shaping the flocculent structure to obtain the carbon nanotube film comprises the substeps of:
(d3) spreading the carbon nanotube flocculent structure to form a predetermined shape;
(d4) applying a pressure to the spread carbon nanotube flocculent structure; and
(d5) removing the residual solvent contained in the spread flocculent structure to form the carbon nanotube film.

18. The method as claimed in claim 10, wherein separating the flocculent structure from the solvent and shaping the flocculent structure to obtain the carbon nanotube film comprises the substeps of:
(d1′) providing a filtration substrate and an air-pumping funnel;
(d2′) adding the carbon nanotube flocculent structure onto the filtration substrate and putting the filtration substrate into the air-pumping funnel;
(d3′) filtering out the solvent from the carbon nanotube flocculent structures and drying to obtain the carbon nanotube film.

19. The method as claimed in claim 10, further comprising the steps of providing a filtration substrate, and pressing the carbon nanotube film onto a surface of the filtration substrate directly.

20. The method as claimed in claim 10, further comprising the steps of providing a filtration substrate, and adhering the carbon nanotube film onto a surface of the filtration substrate with a binder.
